(19) United States
(12) Patent Application Publication
(10) Pub. No.: US 2003/0189348 A1
(43) Pub. Date: Oct. 9, 2003

(54) Side by side twin spreader and method

(76) Inventor: Lennart Lindstrom, Vallingby (SE)

Correspondence Address: YOUNG & THOMPSON, 745 SOUTH 23RD STREET 2ND FLOOR, ARLINGTON, VA, 22202

(21) Appl. No.: 10/311,598

(22) PCT Filed: Jun. 21, 2001
(86) PCT No.: PCT/SE01/01439

(30) Foreign Application Priority Data
Jun. 22, 2000 (SE) 002351-5

(51) Int. Cl. B66C 1/00

(52) U.S. Cl. 294/81.53

(57) ABSTRACT

A spreader has an elongate main-frame (1) arranged to be suspended in cables from a crane, and twist locks are arranged in the ends of the spreader for simultaneously connecting to two containers (4, 5) arranged in side by side relation. Two pairs of twist locks (3) are arranged in each end of the spreader, the twist locks of each pair having a fixed lateral distance (a) and the pairs of twist locks being laterally movable and controlled for adjustment of a lateral distance (b) between the pairs of twist locks. A method for processing two containers in side by side relation in a single lowering/lifting step, and for adjustment of a lateral distance and/or lateral, relative angle between the two containers during transfer and lowering to release the containers in side by side relation.

### TECHNICAL FIELD

The present invention relates to spreaders as generally defined in the preamble of claim 1. More closely, the invention relates to spreaders for lifting two containers simultaneously, side by side in a lateral plane. In the preferred embodiment, the spreader is designed for adjustment of the relative angle and lateral distance between the containers under the lifting motion. The invention also relates to a method for lifting, moving and lowering of two containers in side by side relation.

In the field of container transport, efforts are continuously made in order to reduce port stops and the time needed for loading/unloading of ships, railroad and road units. Significantly at ship terminals, where large quantities of goods are handled by containers, development is heading towards larger units and towards more rational methods for loading and administration of the large goods quantities. Beside an increasing number of containers reaching 40′ or more in length, the recent development is also directed towards the simultaneous processing of two containers in lifts from ship to shore—or the reverse.

### PRIOR ART

In this technical field spreaders are known with a capacity for lifting a single 40′ container, or optionally two 20′ containers in a single operation as in WO97/39973 (Stinis, N L), e.g. In the last case the two 20′ containers are axially oriented, the end wall of one container facing an end wall of the other. This spreader is also known to have a capacity for adjustment of the spacing between the two 20′ containers longitudinally under lift.

A spreader for lifting two containers in side by side relation is known from SE-A-80034085 (A B Hagglunds & Söner, S E). In this arrangement, two sub-spreaders are pivotally supported by a superstructure in side by side relation for engagement with two containers to be lifted and moved. The sub-spreaders are adjustable lengthwise, but are not able to perform a lateral adjustment of the spacing between the two containers in a lateral plane, or a non-parallel displacement of the two containers.

### SUMMARY OF THE INVENTION

In order to meet a need and desire for even more rational processing and reduction of time required for loading/unloading of containers, the present invention aims to provide a solution wherein a spreader is designed for engaging, lifting, moving and lowering two 40-48 feet containers in side by side relation, with a capacity to adjust the lateral spacing between the containers in a parallel or in a non-parallel displacement, as desired.

This object is met in a spreader as defined by the characterizing features of claim 1, and by a method as advised in claim 10. Advantageous embodiments are defined in the sub-claims.

Briefly, the present invention suggests a spreader having a main frame or main beam supported by cables from a crane. Locking means (twist locks) are arranged in the ends of the spreader for engagement with correspondingly formed corner boxes in the upper corners of a container. More specifically, two pairs of twist locks are arranged in each opposite end of the spreader such that each pair of twist locks is aligned transversely to a longitudinal extension of the spreader. In the transverse direction, each pair is supported with a substantially fixed lateral distance between individual twist locks within each pair, whereas at least one pair of twist locks in each end of the spreader is laterally movable in the transverse direction for adjustment of a lateral spacing between the two pair of twist locks in the end of the spreader.

In a preferred embodiment, the suggested spreader has twist locks arranged in pairs in opposite ends of two sub-frames suspended from the main frame. At least one of the sub-frames is driven and controlled in the transverse direction for separate or contemporaneous adjustment of the lateral distance and/or relative angle in a lateral plane between the two sub-frames, as desired.

By the invention there is also provided a method for simultaneously processing two individual containers in side by side relation by means of a single spreader and crane. In the method, the spreader is lowered for connecting to the two containers arranged side by side, mechanically connecting the eight twist locks of the spreader in a single lowering step. The containers are then lifted and moved side by side to be simultaneously lowered, and optionally, simultaneously disconnected from the spreader. In the lowering and/or transfer motions, the pair of twist locks in both ends of the spreader are optionally driven and controlled transversely to the longitudinal direction of the spreader for positioning the containers in a desired inter-spaced relation, or at a desired relative angular position.

### DRAWINGS

Exemplary embodiments of the invention are further described below, reference being made to the accompanying, schematic drawings wherein

FIG. 1 is an end view showing the fundamental operation of a spreader according to the invention;

FIG. 2 is an end view showing a first embodiment of a spreader according to FIG. 1;

FIG. 3 is a top view showing a pair of sub-frames in the spreader of FIG. 2;

FIG. 4 is an end view showing a second embodiment of the spreader, the sub-frames being supported by rods from a main frame;

FIG. 5 is an end view showing a preferred embodiment of the spreader;

FIG. 6 is a top view of the spreader in FIG. 5;

FIGS. 7a and 7b are end views showing the sub-frames in different lateral positions, and

FIG. 8a-c are end views showing a further embodiment of the spreader, the sub-frames being displaced to different lateral positions.

### DETAILED DESCRIPTION OF EMBODIMENTS

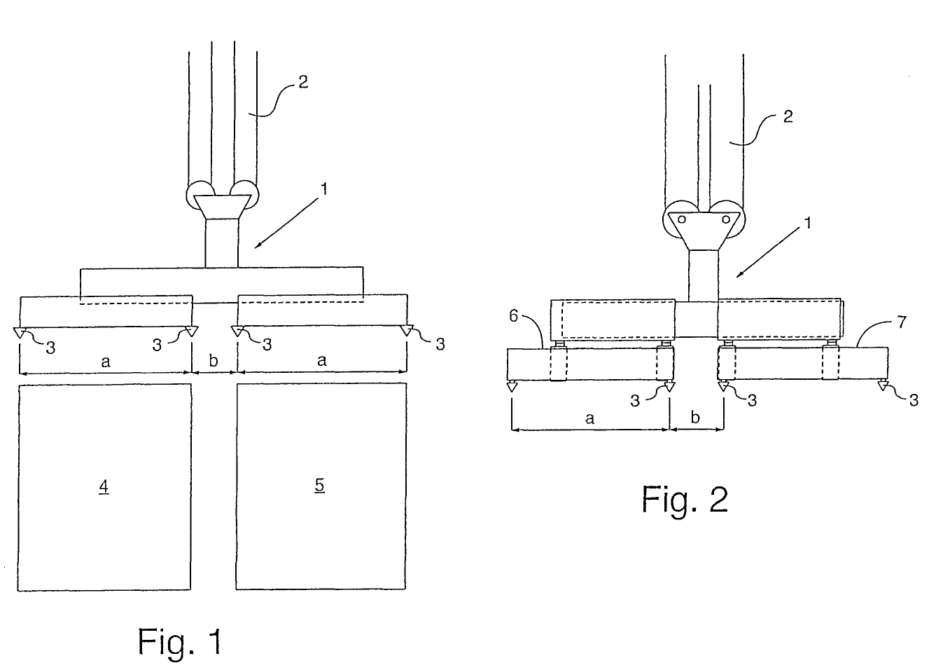

The principals of the spreader according to this invention will now be described with reference to FIG. 1.

An elongate main frame 1 is arranged and supported by cables 2 from a crane (not shown). In each end of the main frame, twist locks 3 are arranged for engagement with correspondingly formed corner boxes in the upper corners of a container. Each opposite end of the spreader carries two pairs of twist locks 3 arranged transversely relative to the longitudinal dimension of the main frame 1. The twist locks 3 of each pair of twist locks are secured at a substantially fixed lateral width a in the transverse direction. At least one pair of twist locks in each end of the main frame is laterally movable relative to the other pair, at least in said transverse direction for adjustment of a relative lateral distance b such that the spreader is connectable to the two containers 4,5 in side by side relation.

A first example of a spreader according to the invention is illustrated in FIG. 2. In the spreader of FIG. 2, twist locks 3 are arranged in pairs in the opposite ends of two sub-frames 6 and 7, respectively, suspended from the main frame 1. At least one of the sub-frames 6,7 is driven and controlled in the transverse direction for adjustment of the lateral width b in one or both ends of the spreader, separately or simultaneously as desired. The operation provides an optional adjustment of the relative angular position between the sub-frames 6,7, and between the containers that are gripped by the twist locks.

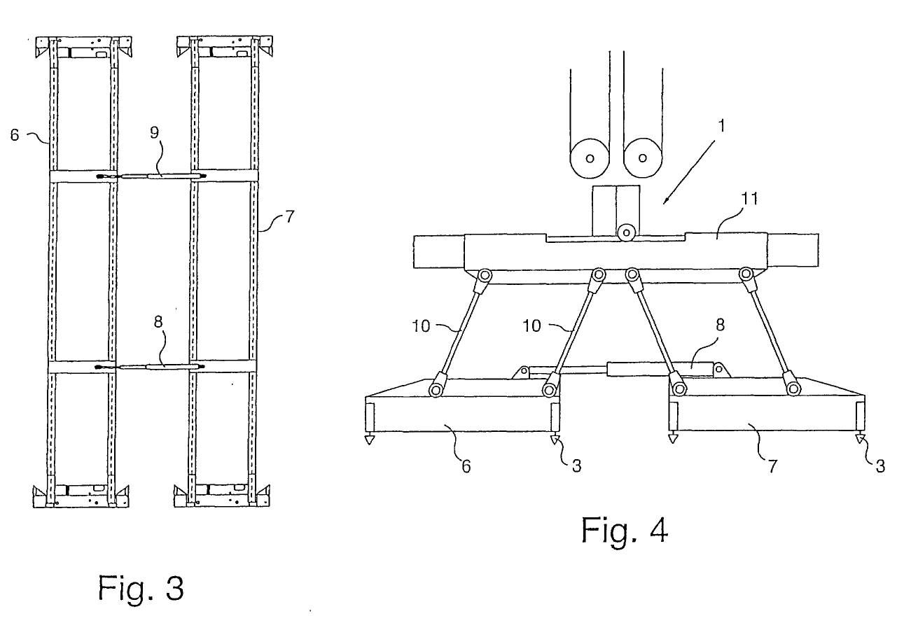

As illustrated in FIG. 3, the sub-frames 6,7 may be interconnected such that the drive means for adjustment of lateral distance and relative angle are arranged to operate directly between the sub-frames. More precisely, the sub-frames 6,7 are interconnected on each side of a longitudinal center of the main frame by means of arms 8,9, respectively, the arms being adjustable relative to the lengths thereof. The arms may be realized as double-acting cylinders 8,9. Each end of the arms 8,9 is pivotally attached to a sub-frame, and separately controlled for adjustment of lateral distance and relative angle between the sub-frames 6,7 and also between the containers 4,5 connected to the twist locks 3. The sub-frames 6,7 may further be telescopic and adjustable relative to the lengths thereof.

FIG. 4 shows a second example of the spreader wherein the sub-frames 6,7 are pivotally suspended by rods 10 in each end of the main frame 1. In this embodiment each end of a sub-frame is suspended by rigid rods of adjustable length forming a parallelepiped, by which will be ensured a substantially lateral or horizontal orientation of the sub-frame, and of a container carried by the sub-frame, upon adjustment of the lateral distance b between sub-frames 6,7.

As illustrated in FIG. 4, the sub-frames 6,7 may be suspended from a common, transverse guide means 11 that is driven and controlled for a lateral displacement of a load center relative to the wires 2.

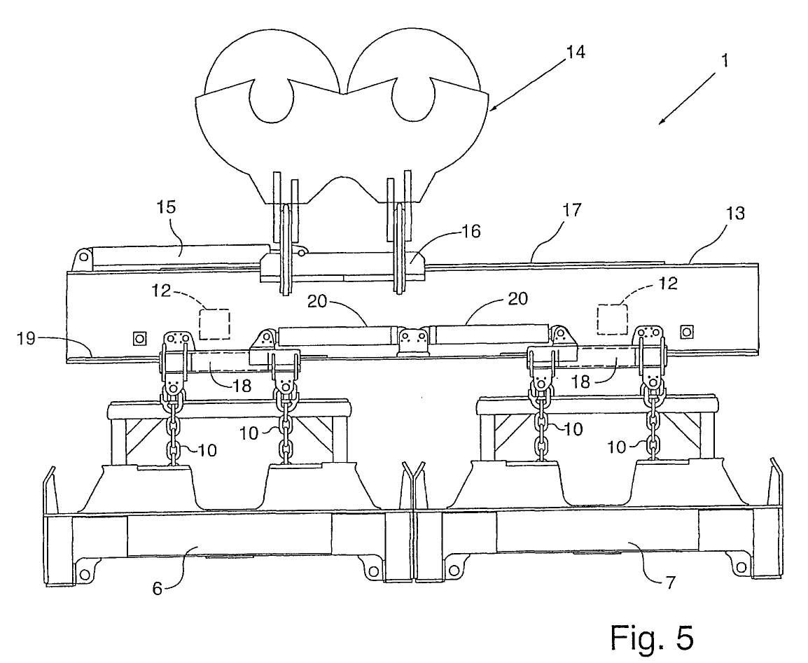

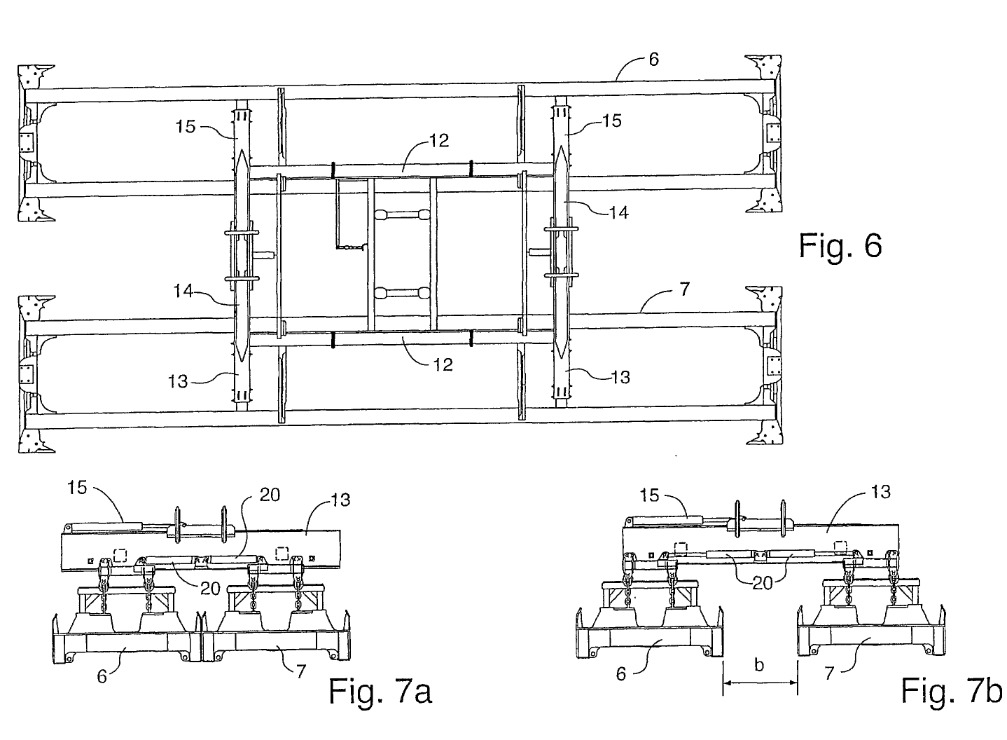

FIG. 5 illustrates a preferred embodiment of the side by side twin spreader according to the invention. A main frame 1 comprises a pair of longitudinal beams 12, the ends of which (shown in broken lines in FIG. 5) are connected to transverse end beams 13, respectively (only one visible in FIG. 5). The main frame 1 has a generally H-formed plan view as will be apparent from FIG. 6.

The end beams 13 are suspended from a trolley 14, hanging in cables from a crane (not shown). The trolley 14 is slidable along the end beam 3, transverse to the longitudinal direction of the spreader 1. The trolley 14 is associated with a driving means 15 that operates between the end beam 13 and the trolley for displacement of the trolley in compensation for a displaced load center due to an uneven load on the sub-frames 6,7. The driving means may be realized as a hydraulic cylinder 15 that moves a carriage 16. The carriage 16 is guided for sliding motion on the end beam 13 by gripping below a flange or slide guide 17, formed near a top portion of the end beam 13.

The sub-frames 6,7 are suspended in rods 10, realized as chains 10, from the end beams 13. The cables 10 run in pairs from each end of the sub-frame, and in parallel relation from the sub-frame to a carriage 18 that is guided for sliding motion on the end beam 13. The carriage 18 may be formed for engagement with a flange or slide guide 19, formed near a bottom portion of the end beam 13. Driving means 20 is arranged to operate between the end beam and the carriage 18 for a lateral displacement of the sub-frame in an axial direction of the end beam 13. The driving means preferably is a hydraulic cylinder 20.

FIG. 7a is an end view showing the sub-frames 6,7 brought together in a closely related position, and FIG. 7b shows the sub-frames in a lateral, symmetrically expanded relation wherein all driving means 20 are equally activated and the sub-frames are running in parallel with a distance b there between. It should be noted that the lateral displacement of the sub-frames is controllable through the driving means 20 for bringing the sub-frames to any desired lateral position, and also for changing the relative angular position such that the sub-frames may be displaced from the parallel relation.

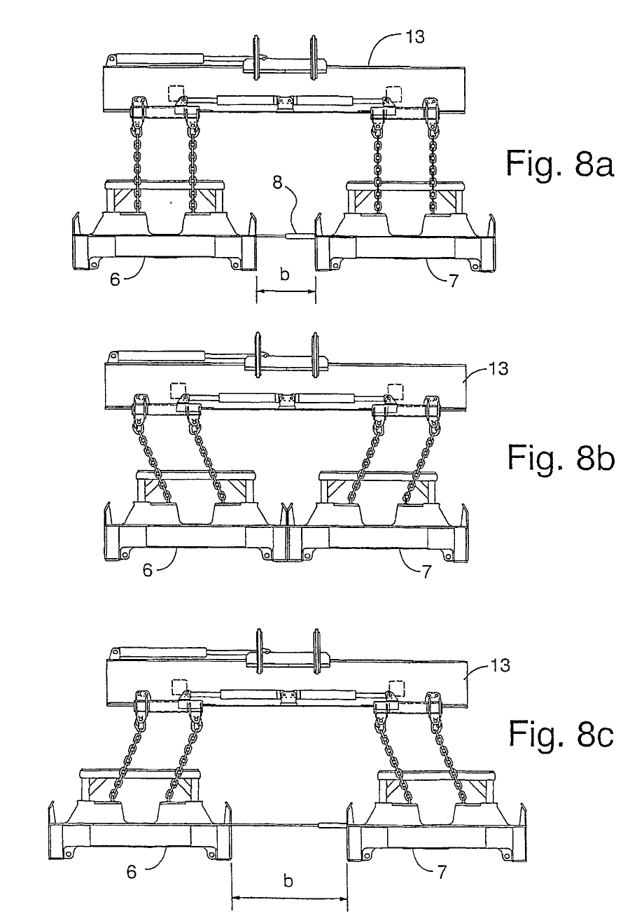

FIGS. 8a-c are end views illustrating an alternative embodiment wherein a further cylinder 8 is arranged to operate directly between the sub-frames 6,7. The drawings show the lateral displacement of the sub-frames while maintaining a substantially planar relation for connecting to the corner boxes of two containers in side by side relation.

Without being illustrated in the drawings or further described herein it should be mentioned that in all embodiments the twist locks 3 may be arranged on the sub-frames for a limited freedom of motion in all radial directions in a plane that is parallel to the sub-frame. The twist locks may also be arranged for a limited freedom of motion relative to the sub-frame in opposite directions transversely to a plane that is parallel to the sub-frame. In order to compensate for a non-planar condition of the containers when lowering the spreader for connection with the corner boxes of containers in side by side relation, or when lowering the containers to rest in a new position on non-planar or leveled grounds, the twist locks may advantageously be axially movable in vertical direction. The vertical movement of the twist locks is preferably damped in at least one vertical direction by means of resilient or elastic elements incorporated in a structure for holding the twist locks in the sub-frame.

The invention provides a method for simultaneously processing two containers in side by side relation with a spreader. In the method, the spreader is lowered for connecting the two containers in one single lowering step by controlling four pairs of twist locks from a main frame. The two containers are lifted and transferred from a first position to be lowered and disconnected side by side in a new position. During transfer and/or lowering of the containers, the twist locks in the ends of the spreader are driven and controlled in pairs for adjustment of a lateral distance b between the containers, and/or for adjustment of the relative angle between the containers in a lateral plane.

The spreader, and the method of the invention, is significantly advantageous for lifting two containers in side by side relation from load cells in a ship. In the lowering step, cell guides of the load cells direct the sub-frames and the drive means for adjusting the lateral distance b may be released. During lift and transfer of the two containers, the lateral distance and relative angle between sub-frames and thus between the containers may be manipulated before lowering the containers to the new position, such as a quay, load vehicle or lorry. The separately controlled pairs of twist locks in the ends of the spreader allow for an accurate positioning of the containers also when the ground surfaces or load platforms are of different heights and not in parallel. The same advantages apply also when the process is reversed.

The invention provides a significant improvement when applied for twin lifts of containers having lengths of 40′ or more. The principles of the invention may naturally be applied for containers of other and shorter lengths as well.

The transversal movements that are utilized in the new spreader may advantageously be produced by electric motors, cylinders driven by air or fluid, gear drives, cables or other driving means and motion transfer means as are known per se in this technical field. Motion control may comprise limit switches, optical detectors and control electronics with software. Load detectors may be incorporated in order to detect uneven load on the spreader.

The motion that is generated for adjusting the lateral distance between the sub-frames may be controlled in respect of a detected load distribution for displacement of one or both sub-frames relative to the end beam, in order to adapt the spreader to the common load center of the two containers. Thus, the spreader provides alternative mechanisms for distribution of the load: through adjustment of the trolley relative to the load center of the containers, and/or through moving the load center by adjustment of one or both sub-frames relative to the trolley.

1. A spreader for simultaneously processing by lifting, transferring and lowering of two containers in side by side relation, the spreader comprising
an elongate main frame (1) arranged to be suspended in cables from a crane;
two sub-frames (6,7), suspended from the main frame and running in the longitudinal direction thereof;
a pair of twist locks (3) arranged in each end of the sub-frames for connection to the upper corners of said two containers, the twist locks of each pair of twist locks being spaced by a fixed lateral distance (a) transversely to the longitudinal dimension of the spreader, and
each pair of twist locks being laterally movable in the transverse direction for adjustment of a lateral distance (b) between the pairs of twist locks in each end of the spreader, characterized by
drive means (20) associated with the sub-frames and controllable for separate adjustment of the lateral distance (b) between the pairs of twist locks in each end of the spreader, and wherein
each sub-frame (6,7) is suspended from the main-frame (1) by means of rods (10) arranged in pairs and running in parallel from each end of the main-frame, and the rods are pivotally connected to the main-frame and the sub-frame, respectively, for a substantially planar, lateral displacement of the sub-frames in order to adjust the lateral distance and/or the relative angle between the sub-frames, and thus between the containers connected to the spreader.

2. The spreader of claim 1, wherein the main-frame (1) comprises two end beams (13) transversely connected to the ends of at least one longitudinal beam (12), each end beam being suspended from a trolley (14) that is displaceable on the end beam in transverse directions of the spreader, and each sub-frame is suspended from the end beams to be individually displaceable in said transverse directions.

3. The spreader of claim 2, wherein each sub-frame (6,7) is associated with a pair of drive means (20) for transverse displacement of the sub-frame, the drive means (20) being arranged to operate between the end beams (13) and the sub-frames (6,7).

4. The spreader of claim 3, wherein the end beam has an upper guide means (17) on which the trolley (14) is controlled for sliding displacement in said transverse directions, and a lower guide means (19) on which the sub-frames are controlled for sliding displacement in side transverse directions.

5. The spreader of claim 4, wherein the trolley (14) is attached to a carriage (16), and a drive means (15) controls the carriage to be guided by the upper guide means (17) in a sliding displacement of the trolley in said transverse directions.

6. The spreader of claim 4, wherein the sub-frame (6,7) is suspended by rods (10) from a carriage (18), and a drive means (20) controls the carriage to be guided by the lower guide means (19) in a sliding displacement of the sub-frame in said transverse directions.

7. The spreader of any previous claim, wherein said rods (10) are formed as cables or chains (10).

8. The spreader of claims 1 to 7, wherein said rods (10) are rigid struts of adjustable length.

9. The spreader of any previous claim, wherein the sub-frames (6,7) are interconnected by additional drive means (8) directly operating between the sub-frames.

10. Method for simultaneously processing by lifting, transferring and lowering of two containers in side by side relation by means of a spreader according to claim 1, wherein
the spreader is lowered to connect with the two containers and then to lift the containers in side by relation in a single lowering/lifting step;
the spreader is controlled to adjust a lateral distance (b) and/or to adjust a lateral relative angle between the containers during transfer, and
the spreader is lowered to release the containers in side by side relation in a single lowering step.

11. The method of claim 10, wherein a common load center for the containers is adjusted by lateral displacement of one or both sub-frames (6,7) relative to the trolley (14) in a transverse direction of the spreader.

12. The method of claim 10, wherein one or both sub-frames (6,7) and the trolley (14) are controlled for lateral displacement relative to a load center of the spreader.

13. The method of any previous claim, wherein the sub-frames (6,7) are controlled for a non-parallel, lateral displacement in a common plane.
